(19) United States
(12) Patent Application Publication
(10) Pub. No.: US 2026/0034968 A1
(43) Pub. Date: Feb. 5, 2026

(54) VEHICLE AND BRAKING CONTROLLER

(71) Applicant: SUBARU CORPORATION, Tokyo (JP)

(72) Inventor: Shunya KITA, Tokyo (JP)

(21) Appl. No.: 19/236,111

(22) Filed: Jun. 12, 2025

(30) Foreign Application Priority Data
Aug. 2, 2024 (JP) 2024-126520

(51) Int. Cl. B60T 8/172; B60T 17/22

(52) U.S. Cl. CPC B60T 8/172; B60T 17/221; B60T 2201/03; B60T 2270/89

(57) ABSTRACT

A vehicle includes a braking device and a control device. The braking device includes a brake disk and a brake pad, and is configured to brake the vehicle by bringing the brake disk and the brake pad into contact. The brake disk is attached to a wheel of the vehicle, and the brake pad is configured to come into contact with the brake disk. The control device is configured to acquire a temperature of the braking device and configured to, when the temperature of the braking device is lower than a threshold temperature, bring the braking device into operation on the occasion of acceleration of the vehicle.

### CROSS-REFERENCE TO RELATED APPLICATIONS

The present application claims priority from Japanese Patent Application No. 2024-126520 filed on Aug. 2, 2024, the entire contents of which are hereby incorporated by reference.

### BACKGROUND

The disclosure relates to a vehicle configured to control a braking device, and a braking controller to be used in such a vehicle.

In general, vehicles include a brake pad and a brake disk, and are braked by a frictional force when the brake pad and the brake disk come into contact. For example, Japanese Unexamined Patent Application Publication (JP-A) No. 2007-6970 discloses a technique of increasing a temperature of a braking device by intermittently pressing a brake pad against a brake disk when the temperature of the braking device is low and the frictional force between the brake pad and the brake disk is unstable.

### SUMMARY

An aspect of the disclosure provides a vehicle including a braking device and a control device. The braking device includes a brake disk and a brake pad, and is configured to brake the vehicle by bringing the brake disk and the brake pad into contact. The brake disk is attached to a wheel of the vehicle. The brake pad is configured to come into contact with the brake disk. The control device is configured to acquire a temperature of the braking device and configured to, when the temperature of the braking device is lower than a threshold temperature, bring the braking device into operation on the occasion of acceleration of the vehicle.

An aspect of the disclosure provides a braking controller including a control device. The control device is configured to acquire a temperature of a braking device configured to brake a vehicle by bringing a brake disk and a brake pad into contact. The control device is configured to, when the temperature of the braking device is lower than a threshold temperature, bring the braking device into operation on the occasion of acceleration of the vehicle.

An aspect of the disclosure provides a vehicle including a braking device and circuitry. The braking device includes a brake disk and a brake pad, and is configured to brake the vehicle by bringing the brake disk and the brake pad into contact. The brake disk is attached to a wheel of the vehicle. The brake pad is configured to come into contact with the brake disk. The circuitry is configured to acquire a temperature of the braking device and configured to, when the temperature of the braking device is lower than a threshold temperature, bring the braking device into operation on the occasion of acceleration of the vehicle.

An aspect of the disclosure provides a braking controller including a circuitry. The circuitry is configured to acquire a temperature of a braking device configured to brake a vehicle by bringing a brake disk and a brake pad into contact. The circuitry is configured to, when the temperature of the braking device is lower than a threshold temperature, bring the braking device into operation on the occasion of acceleration of the vehicle.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram of a configuration example of a vehicle according to an embodiment of the disclosure.

FIG. 2 is a flowchart of an example of operation to warm a braking device, in the vehicle illustrated in FIG. 1.

### DETAILED DESCRIPTION

What is desired for vehicles is to suppress a decline in braking performance when a temperature of a braking device is low, with expectation for ensuring the braking performance.

It is desirable to provide a vehicle and a braking controller that make it possible to suppress a decline in braking performance when a temperature of a braking device is low.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### EMBODIMENTS

### Configuration Example

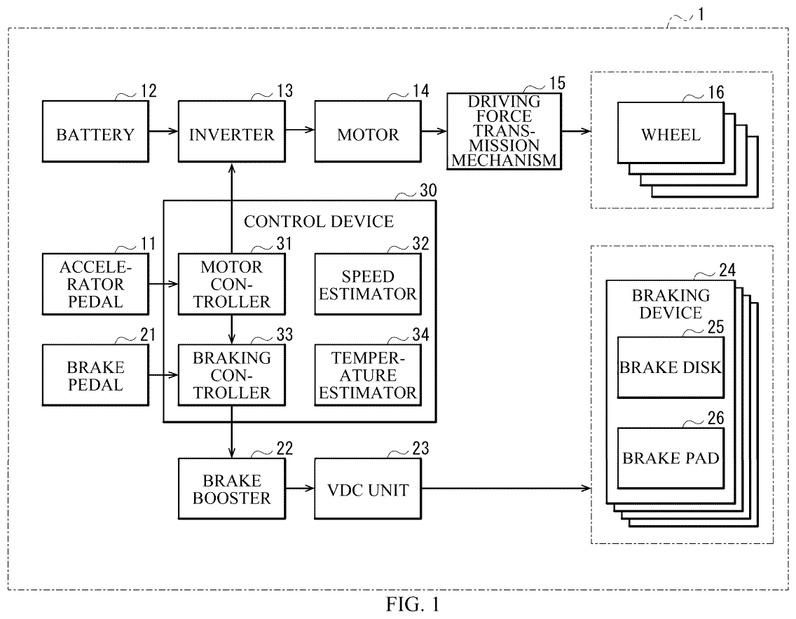

FIG. 1 illustrates a configuration example of a vehicle, i.e., a vehicle 1, according to an embodiment. In this example, the vehicle 1 may include an electric vehicle such as an electric automobile. The vehicle 1 may include, for example, an accelerator pedal 11, a battery 12, an inverter 13, a motor 14, a driving force transmission mechanism 15, four wheels 16, a brake pedal 21, a brake booster 22, a VDC (Vehicle Dynamics Control) unit 23, four braking devices 24, and a control device 30.

The accelerator pedal 11 is configured to accept an acceleration operation by a driver. The driver may make the acceleration operation by stepping down the accelerator pedal 11. The accelerator pedal 11 is configured to accept the acceleration operation.

The battery 12 is configured to accumulate electric power to be used when the vehicle 1 as an electric vehicle travels.

The inverter 13 is configured to convert DC power supplied from the battery 12 into AC power based on an acceleration instruction supplied from the control device 30, and drive the motor 14 using the converted AC power. The inverter 13 is also configured to supply regenerative electric power supplied from the motor 14 to the battery 12.

The motor 14 is configured to generate a driving force based on an AC voltage supplied from the inverter 13. The motor 14 is also configured to generate regenerative electric power when, for example, the vehicle 1 decelerates.

The driving force transmission mechanism 15 is configured to transmit the driving force generated by the motor 14 to the four wheels 16.

Each of the four wheels 16 is configured to allow the vehicle 1 to travel by rotating about an axle based on the driving force supplied from the motor 14 through the driving force transmission mechanism 15. The four wheels 16 may include two right and left wheels 16 in a front part of the vehicle 1 and two right and left wheels 16 in a rear part of the vehicle 1.

The brake pedal 21 is configured to accept a braking operation by the driver. The driver may make the braking operation by stepping down the brake pedal 21. The brake pedal 21 is configured to accept the braking operation.

The brake booster 22 is configured to change pressure of a brake fluid based on a braking instruction supplied from the control device 30. The brake fluid may be oil in this example.

The VDC unit 23 is configured to adjust the pressure of the brake fluid to be supplied to each of the four braking devices 24.

The four braking devices 24 may be provided in corresponding relation to the four wheels 16, and are configured to brake the vehicle 1. Each of the four braking devices 24 may include a brake disk 25 and a brake pad 26. The brake disk 25 is attached to a corresponding one of the wheels 16 and is configured to rotate with the relevant one of the wheels 16. The brake pad 26 is configured to sandwich the brake disk 25 from both sides. The braking device 24 is configured to bring the brake pad 26 and the brake disk 25 into contact with each other by pressing the brake pad 26 against the brake disk 25 in accordance with the pressure of the brake fluid. Thus, in the braking device 24, a frictional force is generated between the brake disk 25 and the brake pad 26, making it possible to brake the vehicle 1 by the frictional force.

The control device 30 may include, for example, an ECU (Electronic Control Unit). The control device 30 may include one or more processors and one or more memories. The control device 30 may include, for example, a motor controller 31, a speed estimator 32, a braking controller 33, and a temperature estimator 34.

The motor controller 31 is configured to give the acceleration instruction to the inverter 13 based on an amount of stepping down of the accelerator pedal 11 by the driver. Moreover, the motor controller 31 is configured to supply data regarding whether the vehicle 1 is accelerating, to the braking controller 33.

The speed estimator 32 is configured to estimate a speed of the vehicle 1. In one example, the speed estimator 32 may estimate the speed of the vehicle 1 based on, for example, information such as a rotation speed of the motor 14. The speed estimator 32 may further estimate an acceleration rate of the vehicle 1 based on temporal changes in the speed of the vehicle 1.

The braking controller 33 is configured to give the braking instruction to the brake booster 22 based on an amount of stepping down of the brake pedal 21 by the driver. Moreover, in a case where a temperature estimated by the temperature estimator 34 is lower than a predetermined threshold temperature, when the vehicle 1 is accelerating, the braking controller 33 may give the braking instruction to the brake booster 22 to bring the braking device 24 into operation to an extent that the acceleration of the vehicle 1 is not hindered. This makes it possible for the vehicle 1, when the temperature of the braking device 24 is low in, for example, a cold district, to warm the braking device 24 as soon as possible after a start of travel, leading to suppression of a decline in braking performance.

The temperature estimator 34 is configured to estimate the temperature of the braking device 24. In one example, the temperature estimator 34 may estimate the temperature of the braking device 24 based on, for example, an amount of braking and braking time. The amount of braking indicates magnitude of the braking force in the braking device 24. The braking time means time for which the braking force is applied.

In one embodiment of the disclosure, the braking device 24 may serve as a “braking device.” In one embodiment of the disclosure, the brake disk 25 may serve as a “brake disk.” In one embodiment of the disclosure, the brake pad 26 may serve as a “brake pad.” In one embodiment of the disclosure, the control device 30 may serve as a “control device.”

### Operation and Workings

Next, operation and workings of the vehicle 1 according to the embodiment are described.

### Overview of Overall Operation

First, an overview of the overall operation of the vehicle 1 is given with reference to FIG. 1. The accelerator pedal 11 may accept the acceleration operation by the driver. The battery 12 may accumulate electric power to be used when the vehicle 1 as the electric vehicle travels. The inverter 13 may convert the DC power supplied from the battery 12 into AC power based on the acceleration instruction supplied from the control device 30, and drive the motor 14 using the converted AC power. The inverter 13 may supply the regenerative electric power supplied from the motor 14 to the battery 12. The motor 14 may generate the driving force based on the AC voltage supplied from the inverter 13. Moreover, the motor 14 may generate the regenerative electric power when, for example, the vehicle 1 decelerates. The driving force transmission mechanism 15 may transmit the driving force generated by the motor 14 to the four wheels 16. Each of the four wheels 16 may allow the vehicle 1 to travel by rotating about the axle based on the driving force supplied from the motor 14 through the driving force transmission mechanism 15.

The brake pedal 21 may accept the braking operation by the driver. The brake booster 22 may change the pressure of the brake fluid based on the braking instruction supplied from the control device 30. The VDC unit 23 may adjust the pressure of the brake fluid to be supplied to each of the four braking devices 24. The four braking devices 24 may brake the vehicle 1.

The motor controller 31 of the control device 30 may give the acceleration instruction to the inverter 13 based on the amount of stepping down of the accelerator pedal 11 by the driver. The speed estimator 32 may estimate the speed and the acceleration rate of the vehicle 1. The braking controller 33 may give the braking instruction to the brake booster 22 based on the amount of stepping down of the brake pedal 21 by the driver. Moreover, in the case where the temperature estimated by the temperature estimator 34 is lower than the predetermined temperature, when the vehicle 1 is accelerating, the braking controller 33 may give the braking instruction to the brake booster 22 to bring the braking device 24 into operation to an extent that influences on the acceleration of the vehicle 1 are suppressed. The temperature estimator 34 may estimate the temperature of the braking device 24.

### Detailed Operation

In the vehicle 1, when the temperature of the braking device 24 is low, the braking device 24 is warmed by bringing the braking device 24 into operation when the vehicle 1 is accelerating. In the following, this operation is described in detail.

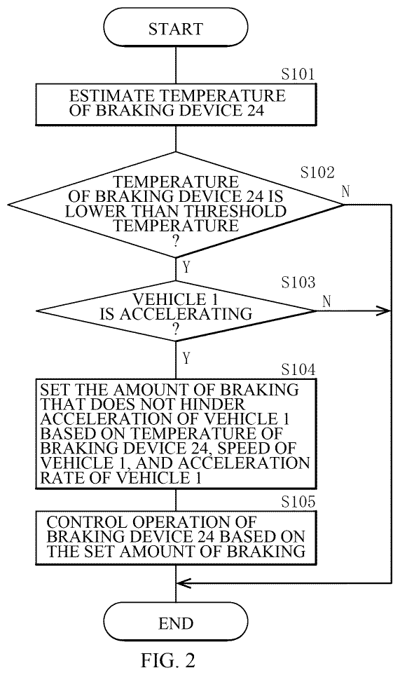

FIG. 2 illustrates an example of operation to warm the braking device 24, in the vehicle 1.

First, the temperature estimator 34 of the control device 30 may estimate the temperature of the braking device 24 (step S101). In one example, the temperature estimator 34 may estimate the temperature of the braking device 24 based on the amount of braking and the braking time. The amount of braking indicates the magnitude of the braking force in the braking device 24. The braking time means the time for which the braking force is applied.

Thereafter, the braking controller 33 of the control device 30 may check whether the temperature of the braking device 24 is lower than the threshold temperature (step S102). When the temperature of the braking device 24 is equal to or higher than the threshold temperature (“N” in step S102), the flow may end.

In step S102, when the temperature of the braking device 24 is lower than the threshold temperature (“Y” in step S102), the braking controller 33 may check whether the vehicle 1 is accelerating, based on the data from the motor controller 31 (step S103). When the vehicle 1 is not accelerating, the flow may end.

When the vehicle 1 is accelerating (“Y” in step S103), the braking controller 33 may set the amount of braking by the braking device 24 that does not hinder the acceleration of the vehicle 1, based on the temperature of the braking device 24, and the speed and the acceleration rate of the vehicle 1 (step S104). In one example, the speed estimator 32 may estimate the speed of the vehicle 1 while estimating the acceleration rate of the vehicle 1 based on the temporal changes in the speed of the vehicle 1. The braking controller 33 may set the amount of braking that does not hinder the acceleration of the vehicle 1, while bringing the brake pad 26 into contact with the brake disk 25, based on the temperature of the braking device 24 estimated in step S101 and the speed and acceleration rate of the vehicle 1.

The braking controller 33 may control the operation of the braking device 24 based on the amount of braking set in step S104 (step S105). Thus, the braking device 24 may bring the brake pad 26 into contact with the brake disk 25 to an extent that the acceleration of the vehicle 1 is not hindered. Accordingly, in the braking device 24, the frictional force is generated between the brake disk 25 and the brake pad 26. By the frictional force, the braking device 24 is warmed.

Thus, the flow may end. The vehicle 1 may repeat such a flow.

As described, the vehicle 1 includes the braking device 24 and the control device 30. The braking device 24 includes the brake disk 25 and the brake pad 26. The brake disk 25 is attached to the wheel 16 of the vehicle 1. The brake pad 26 is configured to come into contact with the brake disk 25. The braking device 24 is configured to brake the vehicle 1 by bringing the brake pad 26 into contact with the brake disk 25. The control device 30 is configured to acquire the temperature of the braking device 24. When the temperature of the braking device 24 is lower than the threshold temperature, the control device 30 is configured to bring the braking device 24 into operation on the occasion of the acceleration of the vehicle 1. Hence, in the vehicle 1, it is possible to suppress the decline in the braking performance when, for example, the temperature of the braking device 24 is low.

That is, for example, when the vehicle 1 is in a cold region, the temperature of the braking device 24 possibly becomes very low. In such a case, even if the brake pad 26 is brought into contact with the brake disk 25, a desired frictional force cannot be obtained, resulting in possibility that sufficient braking performance is not exhibited. In the vehicle 1, when the temperature of the braking device 24 is lower than the predetermined threshold temperature, the brake pad 26 is brought into contact with the brake disk 25 on the occasion of the acceleration of the vehicle 1. That is, in the vehicle 1, for example, the brake pad 26 is brought into contact with the brake disk 25 during a period in which the vehicle 1 starts to travel and is accelerating. Accordingly, in the braking device 24, the frictional force is generated between the brake disk 25 and the brake pad 26, making it possible to warm the braking device 24 by the frictional force. Hence, in the vehicle 1, it is possible to suppress the decline in the braking performance.

In particular, in the vehicle 1, it is possible to warm the braking device 24 when the vehicle 1 starts to travel and is accelerating. This makes it possible to ensure the braking performance on the occasion of, for example, the first braking after the start of travel. That is, for example, in warming the braking device 24 when the braking device 24 is brought into operation to decelerate the vehicle 1, it is difficult to exert the braking performance on the occasion of the first braking after the start of travel. In contrast, in the vehicle 1 according to the embodiment, the braking device 24 is warmed on the occasion of the acceleration of the vehicle 1. Hence, it is possible to ensure the braking performance on the occasion of the first braking after the start of travel.

In the vehicle 1, the vehicle 1 includes an electric vehicle. The electric vehicle is configured to not only bring the braking device 24 into operation to decelerate the vehicle 1 but also decelerate the vehicle 1 by regenerating energy by the motor 14. Thus, the electric vehicle has low frequency in use of the braking device 24 and does not have many opportunities to warm the braking device 24. In the vehicle 1, applying the technology to the electric vehicle makes it possible to effectively warm the braking device 24 in the electric vehicle having the low frequency in use of the braking device 24, leading to suppression in the decline in the braking performance. Moreover, in such a case with the low frequency in use of the braking device 24, for example, the brake disk 25 may rust. In the vehicle 1, by bringing the brake pad 26 into contact with the brake disk 25, the rust on the contact surface between the brake pad 26 and the brake disk 25 is removed, making it possible to smooth the contact surface. Hence, it is possible to ensure the braking performance.

Furthermore, in the vehicle 1, the braking device 24 is warmed on the occasion of the acceleration of the vehicle 1 as the electric vehicle. This makes it possible to suppress electric costs of the vehicle 1 and influences on a cruising distance of the vehicle 1. That is, for example, in warming the braking device 24 when the braking device 24 is brought into operation to decelerate the vehicle 1, the vehicle 1 has less opportunities to regenerate energy by the motor 14 to brake the vehicle 1. This causes a decrease in an amount of energy to be regenerated. In contrast, in the vehicle 1, because the braking device 24 is warmed on the occasion of the acceleration of the vehicle 1, the amount of energy to be regenerated in this way does not decrease. Hence, it is possible to suppress the electric costs of the vehicle 1 and the influences on the cruising distance of the vehicle 1.

In addition, in the vehicle 1, the control device 30 may calculate the amount of braking by the braking device 24 based on one or more of the temperature of the braking device 24, the travel speed of the vehicle 1, and the acceleration rate of the vehicle 1. When the temperature of the braking device 24 is lower than the threshold temperature, the control device 30 is configured to bring the braking device 24 into operation based on the amount of braking on the occasion of the acceleration of the vehicle 1. Accordingly, in the vehicle 1, it is possible to bring the brake pad 26 into contact with the brake disk 25 to the extent that the acceleration is not hindered. That is, the amount of braking that does not hinder the acceleration may vary with, for example, the temperature of the braking device 24, the travel speed of the vehicle 1, the acceleration rate of the vehicle 1, and the like. Thus, in the vehicle 1, the control device 30 may calculate the amount of braking by the braking device 24 based on the temperature of the braking device 24, the travel speed of the vehicle 1, and the acceleration rate of the vehicle 1. Hence, in the vehicle 1, it is possible to bring the braking device 24 into operation based on, for example, an appropriate amount of braking that does not hinder the acceleration.

### Effects

As described above, in the embodiment, the braking device and the control device are provided. The braking device includes the brake disk and the brake pad. The brake disk is attached to the wheel of the vehicle. The brake pad is configured to come into contact with the brake disk. The braking device is configured to brake the vehicle 1 by bringing the brake pad into contact with the brake disk. The control device is configured to acquire the temperature of the braking device. When the temperature of the braking device is lower than the threshold temperature, the control device is configured to bring the braking device into operation on the occasion of the acceleration of the vehicle. Hence, it is possible to suppress the decline in the braking performance when the temperature of the braking device is low. In particular, it is possible to ensure the braking performance on the occasion of the first braking after the start of travel.

In the embodiment, because the vehicle 1 includes the electric vehicle, it is possible to effectively warm up the braking device in the electric vehicle having the low frequency in use of the braking device. This leads to the suppression of the decline in the braking performance. Moreover, in the electric vehicle having the low frequency in use of the braking device, it is possible to smooth the contact surface. This makes it possible to ensure the braking performance. In addition, it is possible to suppress the electric costs of the vehicle and the influences on the cruising distance of the vehicle.

In the embodiment, the control device is configured to calculate the amount of braking by the braking device based on one or more of the temperature of the braking device, the travel speed of the vehicle 1, and the acceleration rate of the vehicle 1. When the temperature of the braking device is lower than the threshold temperature, the control device is configured to bring the braking device into operation based on the amount of braking on the occasion of the acceleration of the vehicle. Hence, it is possible to bring the braking device into operation based on, for example, an appropriate amount of braking that does not hinder the acceleration.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the forgoing embodiment, the technology is applied to an electric vehicle, but this is non-limiting. Alternatively, the technology may be applied to, for example, a vehicle using an engine as a driving force source.

For example, in the forgoing embodiment, the control device is configured to acquire the temperature of the braking device 24 by allowing the temperature estimator 34 to estimate the temperature of the braking device 24. However, this is non-limiting. Alternatively, for example, a temperature sensor may be provided on the braking device 24, and the control device 30 may acquire the temperature detected by the temperature sensor.

For example, in the forgoing embodiment, as illustrated in step S104 in FIG. 2, the braking controller 33 may set the amount of braking by the braking device 24 based on the temperature of the braking device 24, the speed of the vehicle 1, and the acceleration rate of the vehicle 1. However, this is non-limiting. Alternatively, the braking controller 33 may set the amount of braking by the braking device 24 based on one or more of the temperature of the braking device 24, the speed of the vehicle 1, and the acceleration rate of the vehicle 1.

It is to be noted that the effects described in the specification are merely examples. Effects of the disclosure are not limited to the effects described in the specification. The disclosure may produce other effects than described in the specification.

Furthermore, the disclosure may take the following configurations.

(1)

A vehicle including:
a braking device including a brake disk and a brake pad, and configured to brake the vehicle by bringing the brake disk and the brake pad into contact, the brake disk being attached to a wheel of the vehicle, and the brake pad being configured to come into contact with the brake disk; and
a control device configured to acquire a temperature of the braking device and configured to, when the temperature of the braking device is lower than a threshold temperature, bring the braking device into operation on an occasion of acceleration of the vehicle.
   (2)

The vehicle according to (1) described above, in which
the control device is configured to:
   calculate an amount of braking by the braking device based on one or more of the temperature of the braking device, a travel speed of the vehicle, and an acceleration rate of the vehicle; and
   when the temperature of the braking device is lower than the threshold temperature, bring the braking device into operation based on the amount of braking, on the occasion of the acceleration of the vehicle.
      (3)

A braking controller including
a control device configured to acquire a temperature of a braking device configured to brake a vehicle by bringing a brake disk and a brake pad into contact, and configured to, when the temperature of the braking device is lower than a threshold temperature, bring the braking device into operation on an occasion of acceleration of the vehicle.

The control device 30 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control device 30. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control device 30 illustrated in FIG. 1.

1. A vehicle comprising:
a braking device including a brake disk and a brake pad, and configured to brake the vehicle by bringing the brake disk and the brake pad into contact, the brake disk being attached to a wheel of the vehicle, and the brake pad being configured to come into contact with the brake disk; and
a control device configured to acquire a temperature of the braking device and configured to, when the temperature of the braking device is lower than a threshold temperature, bring the braking device into operation on an occasion of acceleration of the vehicle.

2. The vehicle according to claim 1, wherein
the control device is configured to:
calculate an amount of braking by the braking device based on one or more of the temperature of the braking device, a travel speed of the vehicle, and an acceleration rate of the vehicle; and
when the temperature of the braking device is lower than the threshold temperature, bring the braking device into operation based on the amount of braking, on the occasion of the acceleration of the vehicle.

3. A braking controller comprising
a control device configured to acquire a temperature of a braking device configured to brake a vehicle by bringing a brake disk and a brake pad into contact, and configured to, when the temperature of the braking device is lower than a threshold temperature, bring the braking device into operation on an occasion of acceleration of the vehicle.

4. A vehicle comprising:
a braking device including a brake disk and a brake pad, and configured to brake the vehicle by bringing the brake disk and the brake pad into contact, the brake disk being attached to a wheel of the vehicle, and the brake pad being configured to come into contact with the brake disk; and
circuitry configured to acquire a temperature of the braking device and configured to, when the temperature of the braking device is lower than a threshold temperature, bring the braking device into operation on an occasion of acceleration of the vehicle.

5. A braking controller comprising
circuitry configured to acquire a temperature of a braking device configured to brake a vehicle by bringing a brake disk and a brake pad into contact, and configured to, when the temperature of the braking device is lower than a threshold temperature, bring the braking device into operation on an occasion of acceleration of the vehicle.
